(19) United States
(12) Patent Application Publication
(10) Pub. No.: US 2024/0419131 A1
(43) Pub. Date: Dec. 19, 2024

(54) METHOD AND APPARATUS FOR CONTROLLING CLAUS PROCESS BASED ON REINFORCEMENT LEARNING

(71) Applicant: POSTECH RESEARCH AND BUSINESS DEVELOPMENT FOUNDATION, Pohang-si (KR)

(72) Inventors: Young Joo SUH, Pohang-si (KR); Dong Deok KIM, Pohang-si (KR)

(73) Assignee: POSTECH RESEARCH AND BUSINESS DEVELOPMENT FOUNDATION, Pohang-si (KR)

(21) Appl. No.: 18/368,506

(22) Filed: Sep. 14, 2023

(30) Foreign Application Priority Data
Jun. 13, 2023 (KR) 10-2023-0075592

(51) Int. Cl. G05B 13/02

(52) U.S. Cl. CPC G05B 13/0265

(57) ABSTRACT

A method of controlling a Claus process based on reinforcement learning is proposed. The method includes receiving by a controller, a state value of the Claus process, inputting, by the controller, the state value of the Claus process into a reinforcement learning model, and controlling, by the controller, the Claus process based on an action value output from the reinforcement learning model.

### CROSS REFERENCE TO RELATED APPLICATION

The present application claims priority to Korean Patent Application No. 10-2023-0075592, filed Jun. 13, 2023, the entire contents of which is incorporated herein for all purposes by this reference.

### BACKGROUND OF THE INVENTION

### Field of the Invention

Technology described below relates to a method and apparatus for controlling a Claus process by using reinforcement learning.

### Description of the Related Art

Coke Oven Gas (COG), which is a by-product gas generated in a process of producing coke, is used for power generation in steelworks or is injected as fuel into a working process. However, since the COG includes impurities such as ammonia (NH₃), hydrogen sulfide (H₂S), and BTX (i.e., benzene, toluene, and xylene), it should be purified before use.

In order to purify COG, a chemical conversion process for removing impurities from the COG exists in steelworks. In the chemical conversion process, there are provided facilities such as an H₂S absorption tower, an NH₃ absorption tower, and a BTX absorption tower. Such absorption towers remove H₂S, NH₃, and BTX, which are included in the COG. The COG that has passed through the chemical conversion process may be used for power generation, fuel, or the like by the removal of the impurities.

In the chemical conversion process, a desulfurization process includes: a collection process of collecting H₂S with an absorption tower using a concentrated ammonia solution; a separation process of separating H₂S from the concentrated ammonia solution in which H₂S is dissolved; and a recovery process of producing sulfur from the separated H₂S gas. Among these processes, the process of producing sulfur from H₂S is mainly composed of a Claus process.

When the Claus process is performed, tail gas is discharged. The tail gas contains H₂S/SO₂, and a ratio of both should be maintained at an appropriate level. The reason is that when H₂S concentration is excessive, emission regulations may be violated, and when SO₂ concentration is excessive, the efficiency of wastewater treatment using microorganisms may be reduced. In addition, the ratio of H₂S/SO₂ in the tail gas is required to be maintained in a stable state so as not to change rapidly over time.

### DOCUMENTS OF RELATED ART

### Patent Documents

Korean Patent No. 10-2209400
Korean Patent No. 10-2484968

### SUMMARY OF THE INVENTION

In order to maintain a constant ratio of H₂S/SO₂ in tail gas of the conventional Claus process, an operating condition of a catalytic oven reactor have been adjusted through PID control, or adjusted depending on an operator's experience. The adjustment performed by the PID control or the operator's experience has a problem in that the ratio of H₂S/SO₂ in the tail gas is not precisely maintained at a set value and the ratio of H₂S/SO₂ may change rapidly because of not promptly responding to changes in process situations.

An objective of the technology described below is to provide a method of controlling an operating condition of a Claus process by using various information and a reinforcement learning model in the Claus process, so as to maintain an appropriate level of a ratio of H₂S/SO₂ in tail gas.

The technology described below provides a method and apparatus for controlling a Claus process based on reinforcement learning in order to solve the above-mentioned problem.

The method of controlling the Claus process based on the reinforcement learning includes: receiving, by a controller, a state value of the Claus process: inputting, by the controller, the state value of the Claus process into a reinforcement learning model; and controlling, by the controller, the Claus process based on an action value output from the reinforcement learning model.

The apparatus for controlling the Claus process based on the reinforcement learning includes: an input device for receiving a state value of the Claus process; a calculation device for inputting the state value of the Claus process to a reinforcement learning model and generating a control signal for controlling the Claus process based on an action value output from the reinforcement learning model; and a storage device for storing the reinforcement learning model.

The reinforcement learning model may be a model configured to output the action value for receiving a maximum compensation value based on the input state value of the Claus process.

The state value in the Claus process may include at least one piece of information from among information related to acid gas, information related to a catalytic oven reactor, information related to a waste heat boiler, information related to a Claus reactor, information related to a condenser, and information related to tail gas.

The compensation value may increase as a ratio of H₂S/SO₂ in the tail gas of the Claus process approaches a preset value.

The action value may include information for controlling the Claus process.

Using the technology described below, the Claus process may be automatically controlled. Using the technology described below, the operating condition of the catalytic oven reactor in the Claus process may be automatically adjusted. In this way, the ratio of H₂S/SO₂ in the tail gas may be maintained at a set value. In addition, environmental regulation problems due to excessive H₂S emission may be reduced, and efficiency reduction of a wastewater treatment process due to excessive emission of SO₂ may be prevented. In addition, rapid changes in the ratio of H₂S/SO₂ in the tail gas may be prevented.

### BRIEF DESCRIPTION OF THE DRAWINGS

FIG. 1 is a view illustrating an exemplary embodiment of a Claus process 100.

FIG. 2 is a view illustrating one of exemplary embodiments in which a controller 200 controls the Claus process 100 on the basis of reinforcement learning.

FIG. 3 is a flowchart 300 of one of the exemplary embodiments of the method of controlling the Claus process based on the reinforcement learning.

FIG. 4 is a view illustrating one of the exemplary embodiments of a configuration of a controller 400 for controlling the Claus process based on the reinforcement learning.

### DETAILED DESCRIPTION OF THE INVENTION

The technology described below may be applied with various changes and may have various exemplary embodiments. The drawings in the specification may describe specific embodiments of the technology described below. However, this is for explanation of the technology described below and is not intended to limit the technology described below to specific embodiments. Therefore, it should be understood that all changes, equivalents, or substitutes included in the idea and technical scope of the technology described below are included in the technology described below.

In the terms used below, singular expressions should be understood to include plural expressions unless the context clearly interprets otherwise. It should be understood that the term “includes”, “comprises”, or the like mean that the described feature, number, step, operation, component, part, or combination thereof exists, but do not preclude possibilities of the presence or addition of one or more other features or numbers, steps, operations, components, parts, or combinations thereof.

Prior to a detailed description of the drawings, it should be clarified that the classification of components in the present specification is merely a classification for each main function of each component. That is, it may be provided such that two or more components described below may be combined into one component, or one component may be divided into two or more components for each more subdivided function. Further, in addition to its main functions, each component to be described below may additionally perform some or all of the functions covered by other components, and naturally, some of the main functions of each component may also be exclusively performed by other components.

In addition, in performing a method or an operation method, each process constituting the method may be performed in a different order from a specified order unless a particular order is clearly described in context. That is, each process may be performed in the same order as specified, may be performed substantially simultaneously, or may be performed in a reverse order.

First, a Claus process in the technology to be described below will be specified.

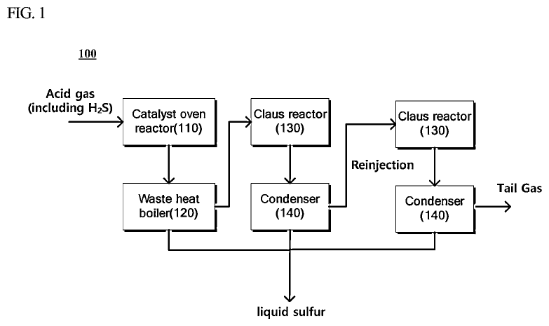

FIG. 1 is a view illustrating an exemplary embodiment of a Claus process 100.

The Claus process 100 may refer to a process of removing or recovering sulfur.

Acid gas input into the Claus process 100 contains H₂S. The acid gas is burned in a catalytic oven reactor, and the following reactions (1) and (2) occur.

2H₂S+3O₂→2SO₂+2H₂O (1)

2H₂S+O₂→+2S+2H₂O (2)

After the reaction in the catalyst oven reactor 110, some of sulfur(S) is condensed through a waste heat boiler 120 so as to recover liquid sulfur.

A Claus reactor 130 is charged with both of SO₂ generated by (1) and unreacted H₂S.

In the Claus reactor 130, chemical reaction such as the following (3) occurs.

2H₂S+SO₂→3S+2H₂O (3)

The sulfur(S) generated by this reaction is condensed into liquid sulfur through a condenser 140.

The reaction of (3) above is a thermodynamic equilibrium reaction. Accordingly, all H₂S are unable to be removed only by performing the process of one Claus reactor 130. In order to additionally recover sulfur from such unreacted H₂S, the processes of the Claus reactor 130 and condenser 140 may be performed again. That is, material obtained after the sulfur is partially condensed in the condenser 140 may also be charged into the Claus reactor 130 again.

Tail gas containing the unreacted H₂S and SO₂ in the Claus process 100 may be reintroduced to the chemical conversion process.

Each component of the Claus process may include a sensor or the like for measuring data.

Hereinafter, the overall process of performing the method of controlling the Claus process based on the reinforcement learning performed by a controller will be described.

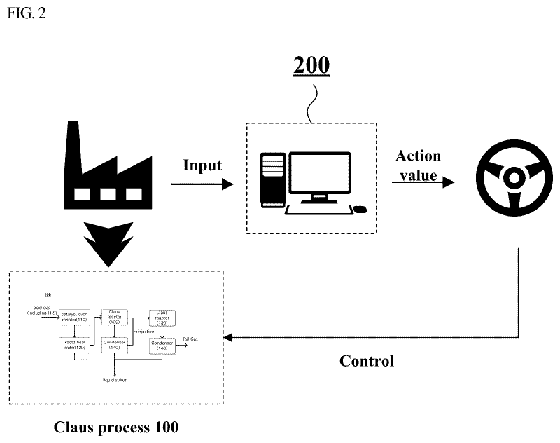

FIG. 2 is a view illustrating one of the exemplary embodiments in which a controller 200 controls a Claus process 100 on the basis of reinforcement learning.

The controller 200 may receive an input of a state value of the Claus process 100. The controller 200 may input the state value of the Claus process 100 to a reinforcement learning model. The controller 200 may control the Claus process 100 on the basis of an action value output by the reinforcement learning model.

The reinforcement learning model may be a model configured to output an action value for receiving a maximum compensation value on the basis of the input state value of the Claus process 100. The compensation value may increase as a ratio of H₂S/SO₂ in tail gas of the Claus process 100 approaches a preset value. The action value may include information for controlling the Claus process.

Hereinafter, a process in which the controller performs the method of controlling the Claus process based on the reinforcement learning will be described in detail.

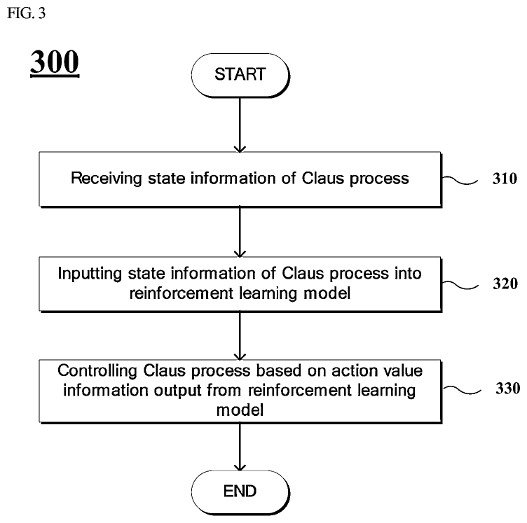

FIG. 3 is a flowchart 300 of one of the exemplary embodiments of the method of controlling the Claus process based on the reinforcement learning.

In step 310, a controller may receive a state value of a Claus process.

The state value in the Claus process may include various information that may be identified in the Claus process. A reinforcement learning model may output an action value by receiving the state value within the Claus process.

The state value in the Claus process may include at least one piece of information from among information related to acid gas, information related to a catalytic oven reactor 110, information related to a waste heat boiler 120, information related to a Claus reactor 130, information related to a condenser 140, and information related to tail gas.

In an exemplary embodiment, the information related to the acid gas may include at least one of pressure, a flow rate, temperature, and H₂S concentration of the acid gas.

In the exemplary embodiment, the information related to the catalytic oven reactor 110 may include at least one of a primary injection amount of air, a secondary injection amount of air, a COG flow rate, an upper temperature, a middle temperature, and a lower temperature of the catalytic oven reactor.

In the exemplary embodiment, the information related to the waste heat boiler 120 may include at least one of an outlet temperature, a feed water flow rate, and a steam flow rate of the waste heat boiler 120.

In the exemplary embodiment, the information related to the Claus reactor 130 may include at least one of an inlet temperature and an outlet temperature of the Claus reactor.

In the exemplary embodiment, the information related to the condenser 140 may include at least one of pressure and a feed water flow rate of the condenser 140.

In the exemplary embodiment, the information related to the tail gas may include pressure of the tail gas, and H₂S concentration and SO₂ concentration in the tail gas.

In step 320, the controller may input the state value of the Claus process to the reinforcement learning model.

The reinforcement learning model may be a model configured to output an action value for receiving a maximum compensation value on the basis of the input state value of the Claus process.

The reinforcement learning model may be a model that may be trained with the reinforcement learning by using a data set created by synthesizing accumulated process data for the Claus process operated for a certain period of time and compensation information for control actions performed during the data accumulation period.

The reinforcement learning model may be a model that may be trained with offline reinforcement learning. That is, the reinforcement learning model does not interact with the Claus process in real time, and may perform the reinforcement learning using the data set accumulated as a result of a conventional Claus process. Accordingly, the reinforcement learning model does not go through trial and error. In addition, the reinforcement learning model may be trained without adversely affecting the productivity and safety of the Claus process in operation.

The reinforcement learning model may be a fine-tuned model that is optimized while interacting with the Claus process in real time after the learning is completed. Specifically, the reinforcement learning model may receive the state value for the current Claus process, control the Claus process by calculating an action value, and then calculate a compensation value accordingly and update a model parameter on the basis of the calculated compensation value.

The compensation value may increase as a ratio of H₂S/SO₂ in tail gas of the Claus process approaches a preset value. Specifically, the compensation value may be set to a negative value of a mean square error between a H₂S/SO₂ ratio and a preset H₂S/SO₂ ratio after controlling the Claus process according to the action value, or the compensation value may be a value designed on the basis of this value.

The action value may include information for controlling the Claus process.

In the exemplary embodiment, the action value may include information for controlling at least one of a primary injection amount of air, a secondary injection amount of air, and a COG flow rate, which are charged into the catalytic oven reactor.

In step 330, the controller may control the Claus process on the basis of action value information output from the reinforcement learning model.

In the exemplary embodiment, the controller may control the catalytic oven reactor 110 on the basis of the action value. For example, when the action value is for the primary injection amount of air injected into the catalytic oven reactor, the primary amount of air injected into the catalytic oven reactor may be injected to match the corresponding action value.

Hereinafter, the controller will be described.

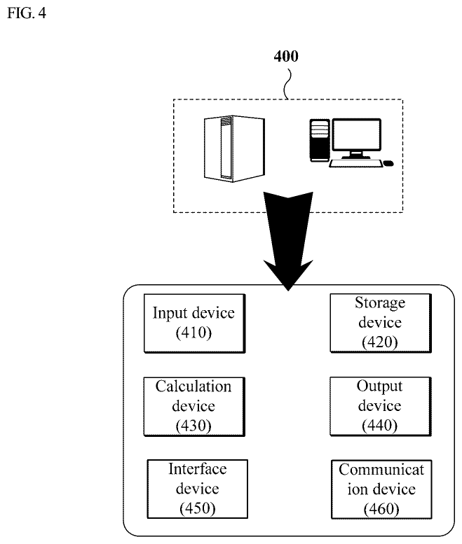

FIG. 4 is a view illustrating an example of a configuration of a controller 400.

The controller 400 may correspond to the controller 200 described in FIG. 2. In other words, the controller 400 may be a device for performing the above-described method of controlling the Claus process based on the reinforcement learning.

The controller 400 may be physically implemented in various forms. For example, the controller 400 may have a form of a PC, a laptop computer, a smart device, a server, or a chipset dedicated to data processing.

The controller 400 may include an input device 410, a storage device 420, a calculation device 430, an output device 440, an interface device 450, and a communication device 460.

The input device 410 may also include an interface device (i.e., a keyboard, a mouse, a touch screen, etc.) for receiving predetermined commands or data. The input device 410 may also include a component for receiving information through a separate storage device (i.e., a USB, a CD, a hard disk, etc.). The input device 410 may also receive input data through a separate measurement device or through a separate DB. The input device 410 may receive the input data through wired or wireless communication.

The input device 410 may receive inputs of information and a model, which are required to perform the method of controlling the Claus process based on the reinforcement learning. The input device 410 may receive an input of a state value of the Claus process. The input device 410 may receive an input of a reinforcement learning model.

The storage device 420 may store the input information received through the input device 410. The storage device 420 may store information generated in a process of calculation by the calculation device 430. That is, the storage device 420 may include a memory. The storage device 420 may store results calculated by the calculation device 430.

The storage device 420 may store the information and model, which are required to perform the method of controlling the Claus process based on the reinforcement learning. The storage device 420 may store the state value of the Claus process. The storage device 420 may store the reinforcement learning model.

The calculation device 430 may be a device such as a processor, an AP, or a chip having an embedded program, which are for processing data and performing predetermined calculation. The calculation device 430 may generate a control signal for controlling the controller.

The calculation device 430 may perform the calculation required to perform the method of controlling the Claus process based on the reinforcement learning. The calculation device 430 may input the state value of the Claus process 100 to the reinforcement learning model. The calculation device 430 may control the Claus process 100 on the basis of an action value output by the reinforcement learning model.

The output device 440 may be a device for outputting predetermined information. The output device 440 may also output an interface required for data processing, input data, analysis results, and the like. The output device 440 may also be physically implemented in various forms, such as a display, a device for outputting documents, and the like. The output device 440 may output a result calculated by the calculation device 430.

The interface device 450 may be a device for receiving predetermined commands and data from the outside. The interface device 450 may receive a state value of the Claus process 100 from a physically connected input device or an external storage device. The interface device 450 may receive a control signal for controlling the controller 400. The interface device 450 may output a result analyzed by the controller 400.

The communication device 460 may refer to a component for receiving and transmitting predetermined information through a wired or wireless network. The communication device 460 may receive the control signal required to control the controller 400. The communication device 460 may transmit the result analyzed by the controller 400.

The above-described method of controlling the Claus process based on the reinforcement learning may be implemented as a program (or an application) including an executable algorithm executable on a computer.

The program may be stored and provided in a transitory or non-transitory computer readable medium.

The non-transitory computer readable medium is not a medium, which stores data for a short moment, such as a register, a cache, a memory, and the like, but a medium that stores data semi-permanently and is readable by a device. Specifically, the various applications or programs described above may be stored and provided in the non-transitory computer readable medium such as a CD, a DVD, a hard disk, a Blu-ray disk, a USB, a memory card, a read-only memory (ROM), a programmable read only memory (PROM), an Erasable PROM (EPROM) or an Electrically EPROM (EEPROM), or a flash memory.

The non-transitory computer readable medium refers to various random access memories (RAMs) such as a static RAM (SRAM), a dynamic RAM (DRAM), a synchronous DRAM (SDRAM), a double data rate SDRAM (DDR SDRAM), an augmented type SDRAM (i.e., an Enhanced SDRAM, ESDRAM), a Synchronized DRAM (i.e., a Synclink DRAM, SLDRAM), and a Direct Rambus RAM (DRRAM).

The present exemplary embodiment and the accompanying drawings in the present specification only clearly show a part of the technical idea included in the above-described technology, and it will be apparent that all modifications and specific exemplary embodiments that can be easily inferred by those skilled in the art within the scope of the technical spirit contained in the specification and drawings of the above-described technology are included in the scope of the above-described technology.

What is claimed is:

1. A method of controlling a Claus process based on reinforcement learning, the method comprising:
receiving, by a controller, a state value of the Claus process;
inputting, by the controller, the state value of the Claus process into a reinforcement learning model; and
controlling, by the controller, the Claus process based on an action value output from the reinforcement learning model,
wherein the reinforcement learning model is a model configured to output the action value for receiving a maximum compensation value based on the input state value of the Claus process,
the state value in the Claus process comprises at least one piece of information from among information related to acid gas, information related to a catalytic oven reactor, information related to a waste heat boiler, information related to a Claus reactor, information related to a condenser, and information related to tail gas,
the compensation value increases as a ratio of H₂S/SO₂ in the tail gas of the Claus process approaches a preset value, and
the action value comprises information for controlling the Claus process.

2. The method of claim 1, wherein the information related to the acid gas comprises at least one of pressure, a flow rate, temperature, and H₂S concentration of the acid gas.

3. The method of claim 1, wherein the information related to the catalytic oven reactor comprises at least one of a primary injection amount of air, a secondary injection amount of air, a COG flow rate, an upper temperature, a middle temperature, and a lower temperature of the catalytic oven reactor.

4. The method of claim 1, wherein the information related to the waste heat boiler comprises at least one of an outlet temperature, a feed water flow rate, and a steam flow rate of the waste heat boiler.

5. The method of claim 1, wherein the information related to the Claus reactor comprises at least one of an inlet temperature and an outlet temperature of the Claus reactor.

6. The method of claim 1, wherein the information related to the condenser comprises at least one of pressure and a feed water flow rate of the condenser.

7. The method of claim 1, wherein the information related to the tail gas comprises pressure of the tail gas, and H₂S concentration and SO₂ concentration in the tail gas.

8. The method of claim 1, wherein the action value comprises information for controlling at least one of a primary injection amount of air, a secondary injection amount of air, and a COG flow rate, which are charged into the catalytic oven reactor.

9. An apparatus for controlling a Claus process based on reinforcement learning, the apparatus comprising:
an input device for receiving a state value of the Claus process;
a calculation device for inputting the state value of the Claus process to a reinforcement learning model and generating a control signal for controlling the Claus process based on an action value output from the reinforcement learning model; and
a storage device for storing the reinforcement learning model,
wherein the reinforcement learning model is a model configured to output the action value for receiving a maximum compensation value based on the input state value of the Claus process,
the state value in the Claus process comprises at least one piece of information from among information related to acid gas, information related to a catalytic oven reactor, information related to a waste heat boiler, information related to a Claus reactor, information related to a condenser, and information related to tail gas,
the compensation value increases as a ratio of H₂S/SO₂ in the tail gas of the Claus process approaches a preset value, and
the action value comprises information for controlling the Claus process.

10. The apparatus of claim 9, wherein the information related to the acid gas comprises at least one of pressure, a flow rate, temperature, and H₂S concentration of the acid gas.

11. The apparatus of claim 9, wherein the information related to the catalytic oven reactor comprises at least one of a primary injection amount of air, a secondary injection amount of air, a COG flow rate, an upper temperature, a middle temperature, and a lower temperature of the catalytic oven reactor.

12. The apparatus of claim 9, wherein the information related to the waste heat boiler comprises at least one of an outlet temperature, a feed water flow rate, and a steam flow rate of the waste heat boiler.

13. The apparatus of claim 9, wherein the information related to the Claus reactor comprises at least one of an inlet temperature and an outlet temperature of the Claus reactor.

14. The apparatus of claim 9, wherein the information related to the condenser comprises at least one of pressure and a feed water flow rate of the condenser.

15. The apparatus of claim 9, wherein the information related to the tail gas comprises pressure of the tail gas, and H₂S concentration and SO₂ concentration in the tail gas.

16. The apparatus of claim 9, wherein the action value comprises information for controlling at least one of a primary injection amount of air, a secondary injection amount of air, and a COG flow rate, which are charged into the catalytic oven reactor.

17. A computer readable recording medium for recording a program for executing the method of controlling the Claus process according to claim 1.
